(19) United States
(12) Patent Application Publication
(10) Pub. No.: US 2008/0232907 A1
(43) Pub. Date: Sep. 25, 2008

(54) Pneumatic Conveying Device for Bulk Material

(75) Inventor: Brian Snowdon, Doncaster (GB)

Correspondence Address: TROUTMAN SANDERS LLP, 600 PEACHTREE STREET , NE, ATLANTA, GA, 30308, US

(73) Assignee: Clyde Materials Handling Limited, East Kilbride (GB)

(21) Appl. No.: 11/629,958

(22) PCT Filed: Jun. 16, 2005
(86) PCT No.: PCT/GB05/02374

§ 371 Date: Mar. 16, 2007

(30) Foreign Application Priority Data
Jun. 18, 2004 (GB) 0413671.9

(51) Int. Cl. B65G 53/60

(52) U.S. Cl. 406/168

(57) ABSTRACT

Apparatus for delivering a bulk material (24) to a location where said bulk material (24) is to be processed, the apparatus comprising means (2) for feeding said bulk material (24) substantially tangentially into a cylindrical vessel (1) via at least two circumferentially spaced apart tangential inlets (14), the vessel (1) being provided at one end with an outlet (10) whereby the bulk material (24) may pass from the vessel (1) to said location while maintaining its configuration.

### FIELD OF THE INVENTION

This invention relates to methods and apparatus for delivering dry bulk material to a location where the material is to be processed.

### BACKGROUND TO THE INVENTION

For certain types of industrial processes there is a need to feed either powdered or granular dry bulk material to a burner or other device for processing the material. Desirably the material should be fed to the processing point in a smooth and even way so as to improve the processing, for instance, combustion of a fuel or the conversion of the material into a different form. Examples of such processes include the feed of metallic concentrate into a “flash furnace”, for instance, the type used in copper smelting.

One current method makes use of a mechanical feeder, such as a drag chain conveyor, to convey material to either side of a downwardly operating burner. The burner does not function well due to an incomplete and variable feed pattern around the burner inlet. Furthermore, pulsations in the feed due to the use of the drag chain conveyor results in the material coming off the end of the conveyor in surges as each slat of the conveyor feeds material into the burner.

This unevenness of feed reduces the efficiency of the burner and also the production efficiency of the flash furnace.

### STATEMENTS OF THE INVENTION

According to the present invention there is provided apparatus for delivering a bulk material to a location where said bulk material is to be processed, the apparatus comprising means for feeding said bulk material substantially tangentially into a cylindrical vessel via at least two circumferentially spaced apart tangential inlets at a speed such that the bulk material within the vessel is of tubular configuration, the vessel being provided at one end with an outlet whereby the bulk material may pass from the vessel to said location while maintaining its tubular configuration.

The present invention also provides a method for delivering a bulk material to a location where said bulk material is to be processed, the method comprising feeding said bulk material substantially tangentially into a cylindrical vessel at a speed such that the bulk material within the vessel is of tubular configuration and feeding said bulk material from said vessel, via an outlet at one end of the vessel, in a tubular configuration to said location.

The bulk material may be, for instance, a powder or in granular form.

Preferably the means for feeding the bulk material to the vessel is a pneumatic conveying means.

The benefit of the formation of the bulk material in a tubular or annular configuration, that is to say, into the form of a circular hollow sleeve, is to improve the combustion or other reaction efficiency by presenting a smooth, circular material flow such that there is an evenness of flow around the full 360° circumference of the discharge from the vessel to the burner, reactor or furnace feed system.

The vessel, in effect a cyclonic device, is provided with at least two tangentially arranged inlets which are circumferentially spaced apart tangential although typically there are four, circumferentially and equally spaced apart tangential inlets. The use of multiple inlets assists in the building up of the even, revolving sleeve of material until there is sufficient material to flow out of the vessel outlet.

Preferably the outlet of the vessel has a diameter which, while less than that of the vessel itself, is nonetheless relatively large in relation to the vessel diameter.

The vessel can be arranged in any orientation, for instance about a horizontal or vertical axis.

Preferably apparatus of the present invention includes means for splitting the material to be fed to the vessel into a plurality of material streams, each stream being fed to a respective tangential vessel inlet. Such a flow splitting device preferably divides the material, and the associated gas flow, into a number of equal flows with a split accuracy of within ±5%.

Preferably the velocity of entry of the gas entering the cyclonic vessel is between 5 and 40 metres/second in order to create the revolving flow of material in the vessel.

Preferably the vessel is additionally provided with means for feeding gas directly thereto.

In another preferred embodiment, the vessel may be provided with means for removing a proportion of material transporting gas.

In one preferred embodiment, the vessel forms the material entry point into a flash furnace burner.

In another preferred embodiment of the present invention, the apparatus is provided with means for feeding different materials into the vessel within which the materials become mixed together. Where the apparatus is provided with a flow-splitting device, the mixing of the materials may take place within this device, within the vessel or within both.

The present invention further includes a method of producing a hollow tube of bulk material within a pneumatic conveying system so as to improve the efficiency of burners or other processing devices.

As indicated above, the vessel, as well as acting as a cyclonic device creating the tubular flow of material, can be used to enable additional air or gas to be added to the central core of the flow or for either a part or all of the transporting gas to be removed before the combined material and gas enters the process. This is useful for furnaces with a reducing atmosphere where excess transport gas is required to be removed or where additional gas or air can be added without disturbing the concentrated circular hollow sleeve of material.

The pneumatic conveying system which may form part of apparatus in accordance with the present invention can be, for instance, a lean phase rotary valve system or a higher pressure continuous feeding system so as to reduce the amount of transport gas entering the device and process. If it is required to add gas to or remove gas from the vessel, this can be achieved through a central connection at that end remote from the outlet. This central connection will normally be of a smaller diameter than that of the main body of the vessel. It will be appreciated that, if gas is removed, there will also be the removal of a small proportion of the material because the device, acting as a cyclone, is not 100% efficient in separating material from transport gas.

Apparatus in accordance with the present invention is ideally suited to feeding metal concentrates to so-called flash furnaces. The objective is to create a smooth rotating sleeve of material that exits the outlet of the vessel with equal amounts of material being discharged around the circumference of the outlet so that there is an even mixture of material and air which improves the efficiency of combustion or the efficiency of any other reaction process.

For certain applications, such as those with large conveying rates, it may be advantageous to feed material using a plurality of feeding devices from the storage location of the material and to use the cyclonic vessel to join together these separate conveying steams. For instance a single rotary valve material feeding device may be replaced by four such devices. The four conveying pipes therefrom are then connected directly to the cyclonic vessel and the four streams of material are blended together in the vessel.

In a similar way, the apparatus may be used to mix together different materials such as ore concentrate and powdered flux before entry to a burner or feed point into a furnace. In the case where the proportion of this addition is small, it may be added through only one of the feed pipes into the cyclonic vessel. Alternatively it could be fed into the conveying pipe between a single material feeding device and a flow splitting device so as to achieve mixing in both the flow splitting device and the cyclonic vessel.

### BRIEF DESCRIPTION OF THE DRAWINGS

The accompanying drawings illustrate examples of the present invention and are as follows:

FIG. 1 shows diagrammatically a complete system incorporating the invention;

FIGS. 2a and 2b are a longitudinal section and plan view respectively of the cyclonic vessel to the system of FIG. 1;

FIGS. 3a and 3b show a longitudinal section and a plan view of a material flow splitter for use in the system of FIG. 1;

FIGS. 4a and 4b are a longitudinal section and plan view respectively of an alternative cyclonic vessel which can be used in the system as shown in FIG. 1; and

FIG. 5 is a longitudinal section showing a cyclonic vessel forming part of apparatus in accordance with the present invention and fitted to a flash furnace burner for metal production.

### DETAILED DESCRIPTION OF THE INVENTION

The present invention will now be described in further detail, with reference to the accompanying drawings.

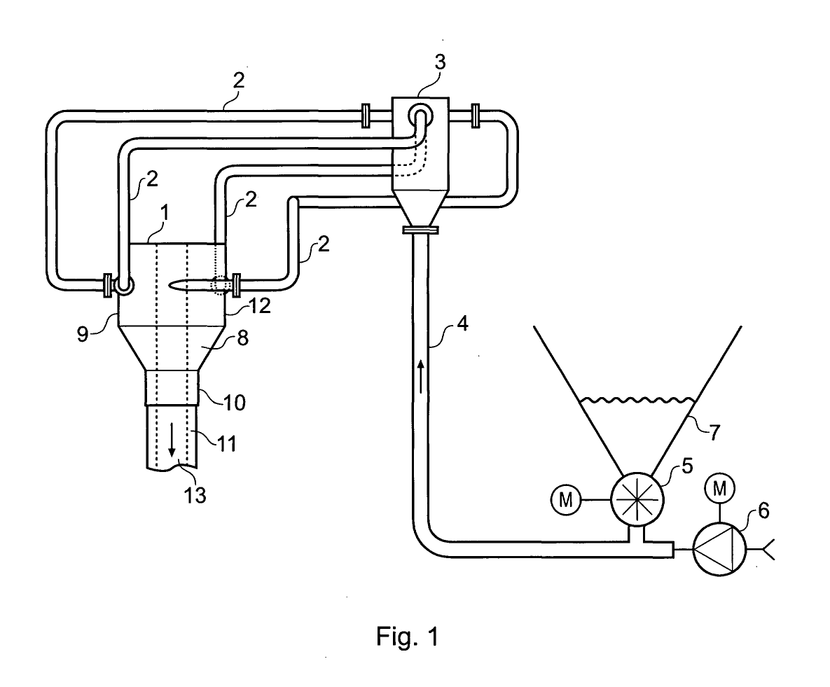

Referring to FIG. 1 of the accompanying drawings, apparatus in accordance with the present invention includes a vessel 1 in the form of a cyclonic collection and feeding device which is connected by four conveying conduits 2 to a flow splitter device 3. The flow splitter device 3 is pneumatically fed with material and transport gas through conveying conduit 4 which is connected to a rotary valve material feeding device 5. A conveying gas blower or compressor 6 provides the conveying gas. Material for conveying is stored in feed hopper 7.

Bulk material is fed into vessel 1 tangentially in such a way as to cause the material in the device to rotate at sufficient speed to ensure the rotating mass of material 8 is forced against the walls of the device 9.

Within the device, the level of bulk material builds up until it flows down an exit pipe 10 as a smooth, thin concentrated hollow sleeve 11. The exit pipe 10 is of smaller diameter than the main body 12 of vessel 1 but is nonetheless of substantial diameter, compared with that of the main body of the vessel. Transport gas 13 flows out of the device in the centre of the sleeve 11.

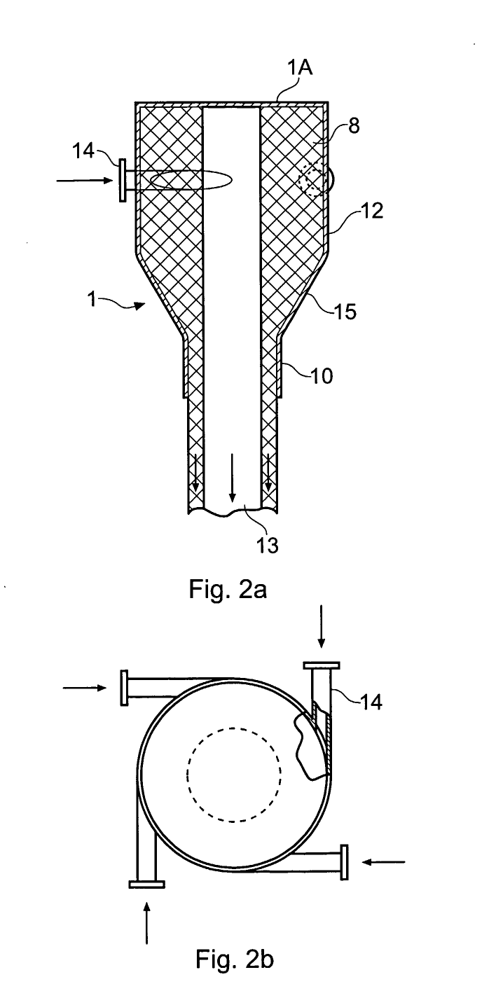

Referring to FIGS. 2a and 2b, there is illustrated one form of vessel 1 for use with the system described above. The vessel is of generally cylindrical shape having a closed end 1A, a main body portion 1B from which extends a narrowing, frusto-conical portion 1C terminating in an outlet 10 having a diameter roughly half that of the main body portion 1B.

Main body portion 1B is provided with four circumferentially and equally spaced apart tangential inlets 14. In use, each inlet will be fed with an approximately equal amount of material and gas for entry into the vessel 1. The velocity of the transporting gas is in the range of from 5 to 40 metres per second in order to maintain the centrifugal effect. The tangential mounting of the inlets 14 on vessel 1 ensures that the metal and transport gas are directed around the walls of vessel 1. A rotating mass of material builds up with the lighter transport gas moving to the centre of the device. The frusto-conical section 15 is such that the dense rotating mass of material builds up until it spills over into the discharge pipe 10. As a result the material leaves the device in a concentrated hollow sleeve of even thickness and density.

By using at least four inlets 14, it is possible to achieve a high throughput, within a relatively small cyclonic vessel 1, whilst achieving a smooth tubular flow pattern.

This tubular flow pattern is maintained even with a relatively long discharge pipe 10. The separated gas flow may have a different forward velocity to that of the material.

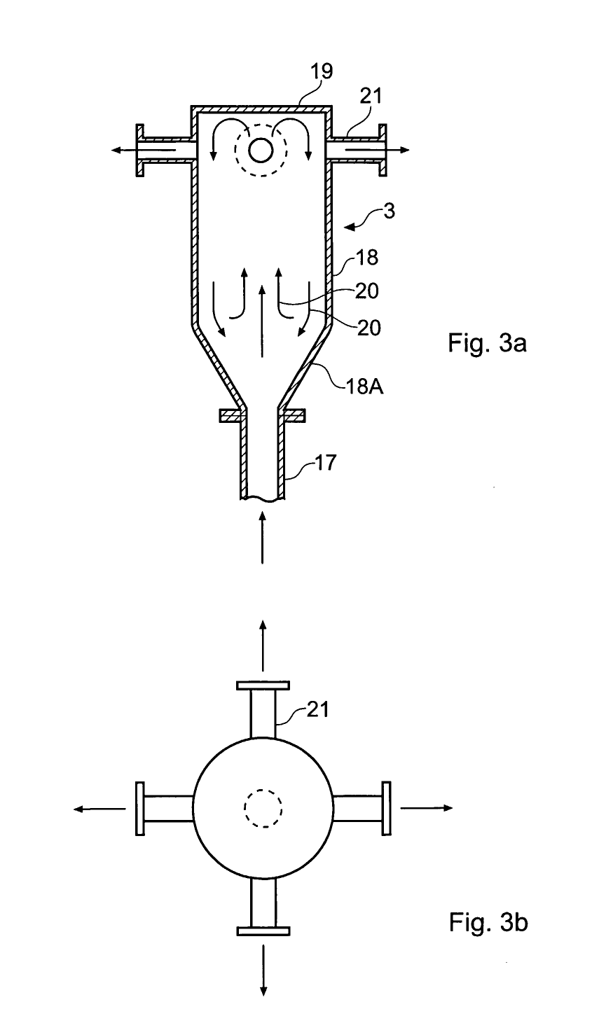

Referring to FIGS. 3a and 3b, there is illustrated the flow splitter 3 in greater detail. The splitter of FIGS. 3a and 3b divides the material and transport gas flow into four equal flows. In other splitters, the numbers of outlets can be from two to eight or even more. Material enters the splitter 3 vertically through inlet pipe 17. The splitter is a substantially cylindrical vessel having a main body portion 18 of constant diameter, a closed end 19 and, opposite closed end 19, frusto-conical portion 18A leading to the narrow inlet pipe 17. This arrangement results in a material flow pattern, indicated by arrows 20, which is similar to that in a circulating fluid bed. The homogenous fluid-like mixture leaves the device through four discharge pipes 21 arranged circumferentially and equally spaced apart at locations close to closed end 19, each discharge pipe 21 extending radially outwardly from the body portion 18 of splitter 3.

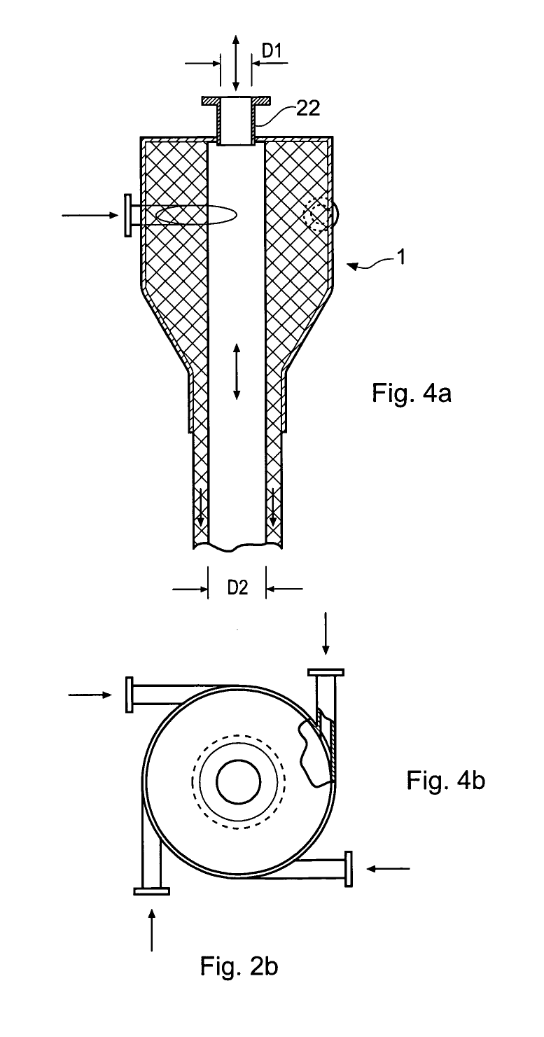

Referring to FIGS. 4a and 4b of the accompanying drawings, there is illustrated an alternative form of cyclonic vessel 1. In this case the vessel 1 is provided with an upper connection 22 which allows conveying gas to be removed or additional gas to be added. The diameter D1 of connection 22 is smaller than the inner core diameter D2 of the rotating mass of material so as not to remove excessive amounts of material when removing gas or disturbing the material flow when adding gas.

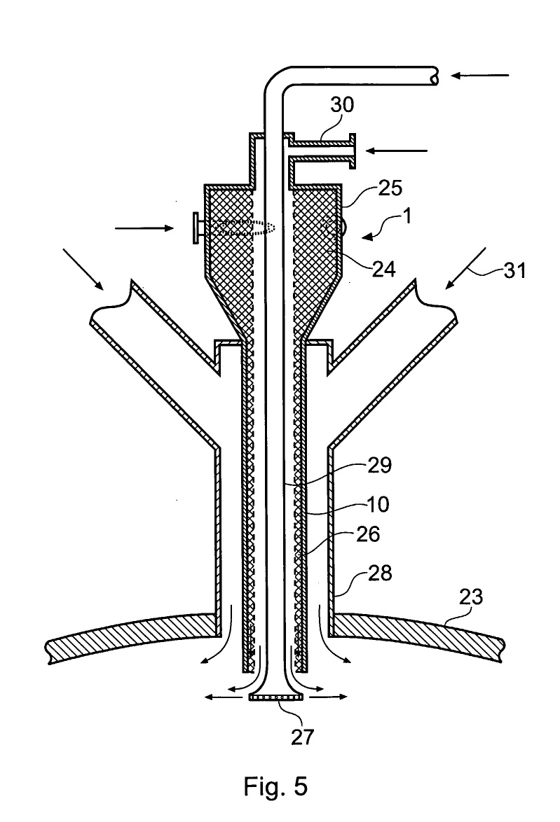

Referring to FIG. 5 of the accompanying drawings, there is shown in detail a cyclonic vessel 1 fitted to a flash furnace burner or material dispersing system used for smelting metallic ore concentrate. The arrangement is mounted in the roof 23 of the furnace. The powdered mineral concentrate 24 is conveyed to the main body 25 of cyclonic vessel 1 and forms a hollow tube of material 26 that progresses downwardly through discharge pipe 10 and exits into the furnace.

The arrangement is also provided with a central air feed pipe 29 which extends centrally through cyclonic vessel 1 and discharge pipe 10 terminating, below the free lower end of discharge pipe 10, in a dispersal element 27 which is provided with air jets arranged to disperse the bulk material evenly into the combustion air 31 supplied through a surrounding circular pipe 28.

The upper end of cyclonic vessel 1 is provided with a central inlet, an associated pipe 30, through which additional gas may be fed into vessel one to increase the downward velocity of the material concentrate.

1. Apparatus for delivering a bulk material to a location where said bulk material is to be processed, the apparatus comprising means for feeding said bulk material substantially tangentially into a cylindrical vessel via at least two circumferentially spaced apart tangential inlets at a speed such that the bulk material within the vessel is of tubular configuration, the vessel being provided at one end with an outlet whereby the bulk material may pass from the vessel to said location while maintaining its tubular configuration.

2. Apparatus according to claim 1, wherein the bulk material is a powder or in granular form.

3. Apparatus according to claim 1, wherein the means for feeding the bulk materials to the vessel is a pneumatic conveying means.

4. Apparatus according to claim 1, wherein the vessel is provided with four, circumferentially and equally spaced apart, tangential inlets.

5. Apparatus according to claim 1, wherein the outlet of the device has a diameter which, while less than that of the vessel itself, is relatively large in relation to the vessel diameter.

6. Apparatus according to claim 1 further including means for splitting the material to be fed to the vessel into a plurality of material streams, each stream being fed to a respective tangential vessel inlet.

7. Apparatus according to claim 1, wherein the velocity of entry of gas entering the vessel is between 5 and 40 metres\second in order to create a revolving flow of material in the vessel.

8. Apparatus according to claim 1, wherein the vessel is additionally provided with means for feeding gas directly thereto.

9. Apparatus according to claim 1, wherein the vessel is provided with means for removing a proportion of material transporting gas.

10. Apparatus according to claim 1, wherein the vessel forms a material entry point into a flash furnace burner.

11. Apparatus according to claim 1 further comprising means for feeding different materials into the vessel within which the materials become mixed together.

12. A method for delivering a bulk material to a location where said bulk material is to be processed, the method comprising feeding said bulk material substantially tangentially into a cylindrical vessel via at least two inlets at a speed such that the bulk material within the vessel is of tubular configuration and feeding said bulk material from said vessel, via an outlet at one end of the vessel, in a tubular configuration to said location.

13. (canceled)

14. (canceled)

15. (canceled)

16. (canceled)

17. Apparatus according to claim 2, wherein the means for feeding the bulk materials to the vessel is a pneumatic conveying means.
